(19) United States
(12) Patent Application Publication
(10) Pub. No.: US 2006/0114775 A1
(43) Pub. Date: Jun. 1, 2006

(54) Optical pickup apparatus

(76) Inventor: Sjoerd Stallinga, EINDHOVEN (NL)

Correspondence Address: PHILIPS INTELLECTUAL PROPERTY & STANDARDS, P.O. BOX 3001, BRIARCLIFF MANOR, NY, 10510, US

(21) Appl. No.: 10/538,619

(22) PCT Filed: Dec. 5, 2003
(86) PCT No.: PCT/IB03/05798

§ 371 Date: Jun. 10, 2005

(30) Foreign Application Priority Data
Dec. 18, 2002 (EP) 02293136.4

(51) Int. Cl. G11B 7/00

(52) U.S. Cl. 369/44.37; 369/112.01

(57) ABSTRACT

The invention relates to an optical pickup apparatus comprising a photodetector (302) which comprises a first segment (A) and a second segment (B), and an optical element (301) intended to receive an incident light beam, said optical element (301) comprising:—a first portion (L) comprising diffraction means for generating a first 0th diffraction order light beam (A(0)) on said first segment (A), and a first non-0th diffraction order light beam (B(+1)) on said second segment (B),—a second portion (R) comprising diffraction means for generating a second 0th diffraction order light beam (B(0)) on said second segment (B), and a second non-0th diffraction order light beam (A(+1)) on said first segment (A) Use: Optical pickup apparatus

### FIELD OF TIE INVENTION

The invention relates to an optical pickup apparatus comprising a photodetector and an optical element intended to receive an incident light beam.

The invention may be used in the field of optical recording.

### BACKGROUND OF THE INVENTION

A method of maintaining a scanning spot on the tracks of an optical disc is known as “push-pull”. This method involves the generation of a tracking error signal referred to as push-pull signal. Said tracking error signal is caused by the interaction of the spot with the groove or other tracking structure placed on the disc surface. A tracking servo adjusts the radial position of the spot to keep the push-pull signal at a predetermined value, usually zero. The push-pull signal is generated by means of a photodetector placed in the optical path of an optical pickup apparatus. The photodetector is in charge of detecting the intensity of the light beam derived from the spot.

The main problem related to the push-pull method is referred to as beamlanding. The spot on the detector can be decentered due to misalignment of the detector or due to the radial movement of the objective lens in the actuator because of the eccentricity of the tracks on the disc. The push-pull signal then has an offset of the points where the push-pull signal crosses the line defined by the predetermined value given by the tracking servo.

A solution to the beamlanding problem is the three-spot push-pull method. In this method, a grating is placed in the beam in the path towards the disc, giving additional satellite spots on the disc. Only the 0th and 1st diffraction orders are taken into account and detected on the detector. The grating is aligned such that the two satellites have a radial offset compared to the main spot of half a track. The two satellite spots generate additional push-pull signals on the detector. The offset due to beamlanding is partly eliminated in that the radial tracking error signal is defined as a weighted sum of the push-pull signals of the main spot and the push-pull signals of the two satellite spots with suitably defined weight coefficients.

This prior art method is subject to limitations.

There are two problems associated with the three-spot push-pull method. A first problem is that the intensity of the main spot is reduced by a considerable fraction, typically around 15%, by the introduction of the three-spot grating. The main part of the intensity loss is consumed by the two satellite spots, and a small part is lost to higher diffraction orders. The reduction in intensity of the main spot has adverse effects on the bit-rate in the writing mode of Recordable or ReWritable systems. A second problem is that of sensitivity to misalignment of the three-spot grating. The orientation of the grating with respect to the track direction must be such that the radial offset of the satellite spots compared to the main spot is half a track. Deviations of this radial spot offset may occur, for example, owing to the so-called y-error, which is a displacement of the optical pickup unit in the direction perpendicular to the line through the centre of the tracks and the main scanning spot. These deviations cause a reduction of the amplitude of the resulting radial tracking error signal, generated according to the three-spot push-pull method. This reduction may also vary as the disc is rotating. This results in an unfavorable variation of the slope of the tracking error signal at the points where the signal crosses the predetermined value given by the tracking servo. The problem associated with y-error is particularly grave for small-sized discs.

### OBJECT AND SUMMARY OF THE INVENTION

It is an object of the invention to propose an optical pickup apparatus which improves the tracking error signal.

To this end, the optical pickup apparatus comprises a photodetector which comprises a first segment and a second segment, and an optical element intended to receive an incident light beam, said optical element comprising:
a first portion comprising diffraction means for generating a first 0th diffraction order light beam on said first segment, and a first non-0th diffraction order light beam on said second segment,
a second portion comprising diffraction means for generating a second 0th diffraction order light beam on said second segment, and a second non-0th diffraction order light beam on said first segment.

The optical pickup implements a detector with at least two segments and an optical element used as a grating for distributing the light beams over the detector segments in such a way that the DC offset caused by the beamlanding is compensated. It directly results in a better tracking error signal.

The optical element is placed in the servo branch of the light path so that the power of the forward beam going to the optical disc is not reduced, contrary to the three-spot push-pull method, where a grating element is placed at the output of the source beam.

A single spot is used, which not only reduces the power consumption, but also eases the realization of the pickup apparatus when dealing with optical discs of small size.

According to additional characteristics, the optical pickup apparatus is such that:
said photodetector comprises a first side segment and a second side segment,
said first portion comprises diffraction means for generating a third non-0th diffraction order light beam on said first side segment, and
said second portion comprises diffraction means for generating a fourth non-0th diffraction order light beam on said second side segment.

The first and second side segments allow to use and to profit from optical elements used as diffraction gratings which generate not only 0th and +1th diffraction order light beams, but also −1st diffraction order light beams.

According to another characteristic, said first portion and said second portion have a saw tooth grating structure with mutually opposed angles.

The use of a grating having a saw tooth structure allows to generate diffracted light beams of high diffraction efficiency.

According to another characteristic, said first portion and said second portion have a binary grating structure.

The use of a grating having a binary structure provides an easy and cost-effective manufacture.

According to additional characteristics:
the first segment comprises a first sub-segment and a second sub-segment,
the second segment comprises a third sub-segment and a fourth sub-segment.

These sub-segments improve the detection of the light beams.

According to another characteristic, the optical element comprises a third portion arranged between said first portion and said second portion.

This third portion allows a central part of the incident light beam to be transmitted directly to the photodetector.

According to another characteristic, the third portion has a width 2*s, where parameter s complies with 0.05*r<s<0.95*r, where r is the radius of said incident light beam.

Such a setting allows a good compromise between the central part of the light beam which is not diffracted, and the peripheral parts which are diffracted by the optical element.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts an optical pickup apparatus according to the invention,

FIG. 2 depicts the cross-section of the light beam at an optical element according to the invention,

FIG. 3 depicts an optical element according to the invention intended to generate diffracted and non-diffracted light beams on a first type of photodetector,

FIG. 4 depicts an optical element according to the invention intended to generate diffracted and non-diffracted light beams on a second type of photodetector,

FIG. 5 depicts a first grating structure of an optical element according to the invention,

FIG. 6 depicts a second grating structure of an optical element according to the invention,

FIG. 7 depicts a third type of photodetector used in the invention.

### DETAILED DESCRIPTION OF THE INVENTION

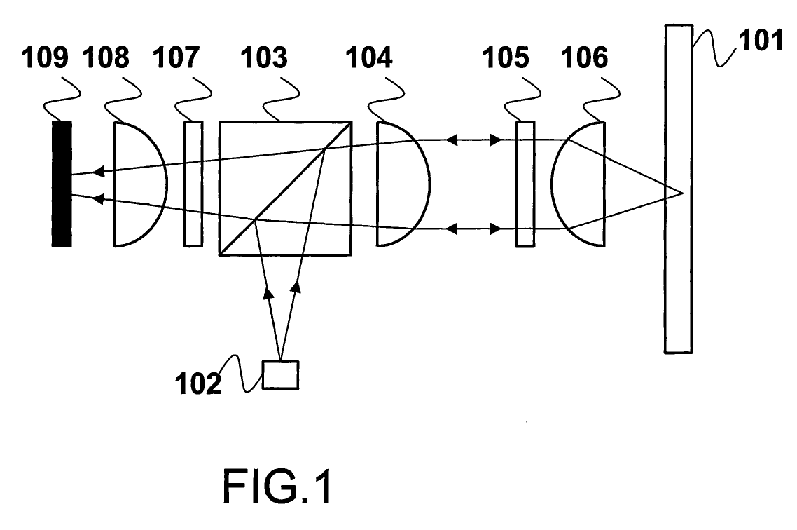

FIG. 1 depicts an optical pickup apparatus according to the invention. This optical pickup apparatus is used for generating electrical signals which are, after processing, used for generating a tracking error signal (also called push-pull signal) intended to maintain the laser beam on tracks of an optical disc 101. In particular, this tracking error signal is intended to keep the laser beam in position in the radial direction of the optical disc 101. The light path is depicted by means of arrows.

The optical pickup apparatus comprises a light source 102 for emitting a laser beam which goes to a beam splitter 103. The beam splitter 103 changes the path of the beam by means of a beam-splitter cube. The beam then passes through a collimator lens 104 which converges the beam so as to force the light rays to be parallel. A quarter-wave plate 105 rotates the plane of polarization of the beam by 45°. The beam then passes through an objective lens 106 and strikes the spiral track of the optical disc 101. On the return path, the quarter-wave plate 105 rotates the polarization of the beam by a further 45°. After having passed through the collimator lens 104, the beam passes through the membrane of the beam splitter 103 and passes through an optical element 107 comprising diffraction means and non-diffraction means. The optical element 107, which will be described in detail in the following, generates a plurality of light beams which pass through an astigmatic servo lens 108. Finally, the optical pickup apparatus comprises a photodetector 109 comprising segments for converting said plurality of light beams into said electrical signals.

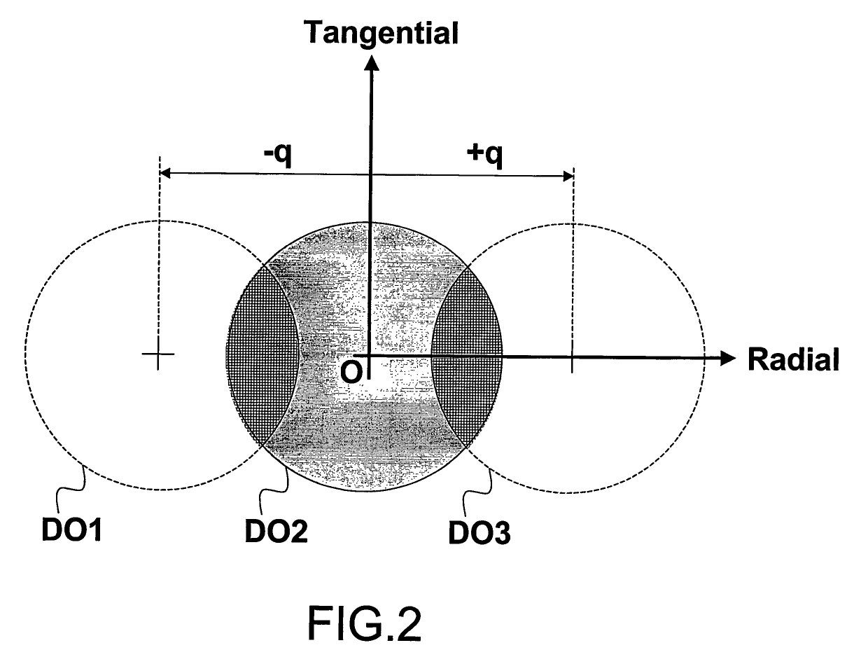

FIG. 2 depicts the cross-section of the incident light beam at the optical element 107 of the pickup apparatus according to the invention. The beam consists of three diffraction orders DO1-DO2-DO3 which partly overlap. Diffraction orders DO1-DO2-DO3 are caused by the track structure of the optical disc which is similar to a diffraction grating.

Relative to the centre O of the 0th order DO2, the +1 st order DO3 is displaced over +q in the radial direction, and the −1st order DO1 is displaced over −q in the radial direction, the radial direction being the radial direction of the circular optical disc.

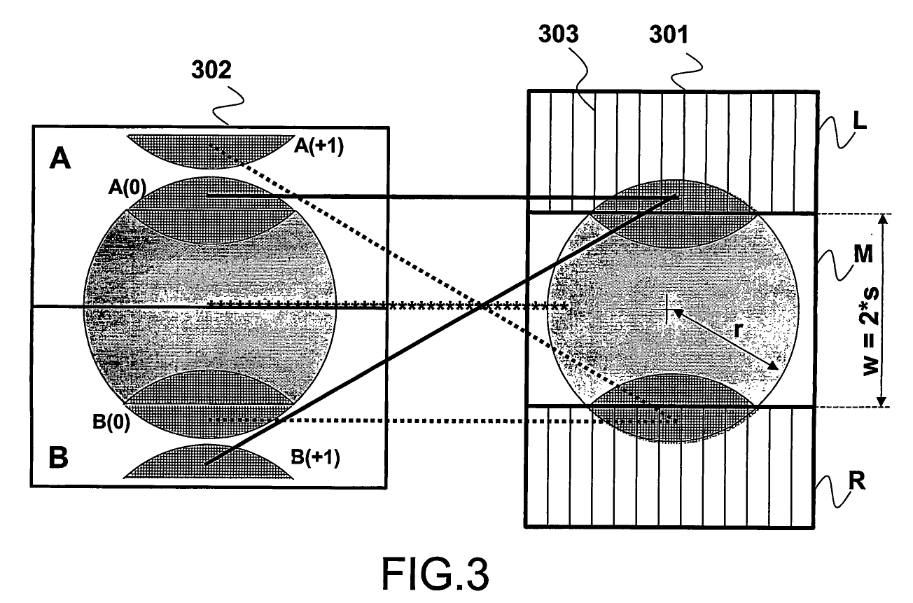

FIG. 3 depicts an optical element 301 according to the invention intended to generate diffracted and non-diffracted light beams on a first type of photodetector 302.

For a better understanding, the optical element 301 and the photodetector 302 are represented in a same plane, and the light rays of the light beams at the output of the optical element are schematically drawn as “full lines”, “dot lines” and “star lines”. Such a representation implicitly takes into account the fact that the astigmatic servo lens referenced to as 108 in FIG. 1 transforms an input light beam into its reflection from the diagonal line, the diagonal line being defined as the line median between the radial and the tangential direction.

This optical element 301 comprises a first side portion L comprising diffraction means, and a second side portion R comprising diffraction means. The diffraction means comprised in the first side portion L and in the second portion R are set so as to distribute diffracted beams over the segments of the photodetector 302 comprising a first segment A and a second segment B.

The diffraction means of the first side portion L are set for generating a first 0th diffraction order light beam A(0) on the first segment A, and a first non-0th diffraction order light beam B(+1) on the second segment B.

The diffraction means of the second side portion R are set for generating a second 0th diffraction order light beam B(0) on the second segment B, and a second non-0th diffraction order light beam A(+1) on the first segment A.

The diffraction means of the first side portion L correspond to a first grating, and the diffraction means of the second side portion R correspond to a second grating. The first and the second grating are made of grooves or ridges 303 arranged along the tangential direction, the axes of said grooves or ridges being parallel to the radial direction.

This optical element 301 may also comprises a central portion M which has no effect on the beam that passes through it. For example, the central area is made of a transparent material.

The first side portion L, the central portion M, and the second side portion R are arranged according to the radial direction.

The width w=2*s of the central portion M is such that s<r, r being the radius of the 0th diffraction order DO2. Preferably, and s being set so as to comply with 0.05*r<s<0.95*r.

The optical element is advantageously made of isotropic material so that the refractive index does not depend on the polarization state of the light beam.

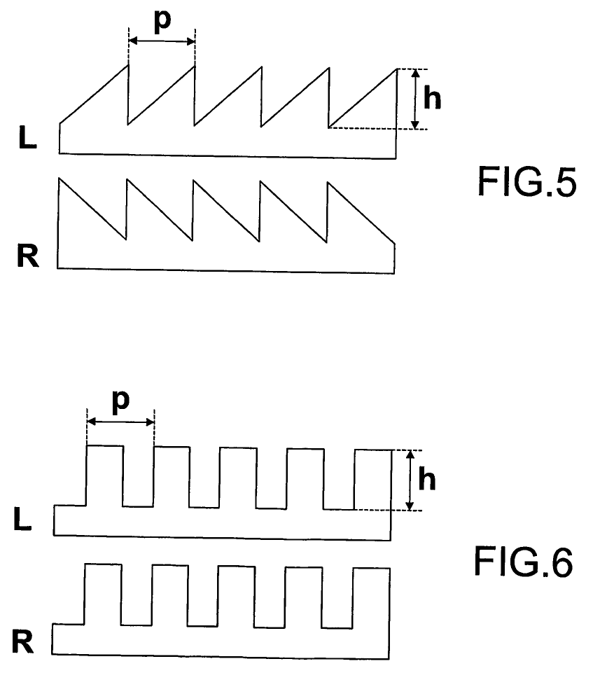

In a first embodiment depicted in FIG. 5, the gratings of the first and second side portions L and R have a saw tooth structure. The saw tooth angle of the first grating and the second grating are mutually opposed.

With such a saw tooth grating structure, the dominant grating diffraction orders are the 0th and the +1st orders. The diffraction efficiency of order m, which indicates the fraction of the intensity going into order m, is defined by:

$${η}_{m} = {[ \frac{sin ( π [ ( n - 1 ) h / λ - m ] )}{π [ ( n - 1 ) h / λ - m ]} ]}^{2} \qquad Eq . 1$$

with λ the wavelength, n the refractive index of the grating material, h the blaze height.

For example, if h=λ/2(n−1), then η₀=η₁=4/π²≈40.5%. Since the cumulated efficiency of all other orders is 19%, they are disregarded.

The angular deviation □□ of order m is related to the wavelength λ, and the pitch p of the grating (corresponding to the structure period) is defined by □□=m.λ/p, provided that □ is small compared with p and that m is sufficiently small. The pitch p of the grating is then chosen so as to make the non-0th diffraction order (i.e. the +1st diffraction order) fall on the opposite segment of the photodetector, with respect to the 0th diffraction order.

In a second embodiment depicted in FIG. 6, the gratings of the first and second side portions L and R have a binary structure.

With such a binary grating structure, the dominant grating diffraction orders are the −1st, 0th and the +1st orders. The diffraction efficiency of order m, which indicates the fraction of the intensity going into order m, is defined by:

$${η}_{m} = \{ \begin{matrix}{cos}^{2} ( π ( n - 1 ) h / λ ) & for m = 0 \\ 0 & for m even \\ \frac{4}{{π}^{2} {m}^{2}} {sin}^{2} ( π ( n - 1 ) h / λ ) & for m odd\end{matrix} \} \qquad Eq . 2$$

with λ the wavelength, n the refractive index of the grating material, h the step height.

The angular deviation □□ of order m is related to the wavelength λ, and the pitch p of the grating (corresponding to the structure period) is defined by □□=m.λ/p, provided that □ is small compared with p and that m is sufficiently small. The pitch p of the grating is then chosen so as to make the non-0th diffraction order (i.e. the +1st diffraction order) fall on the opposite segment of the photodetector, with respect to the 0th diffraction order.

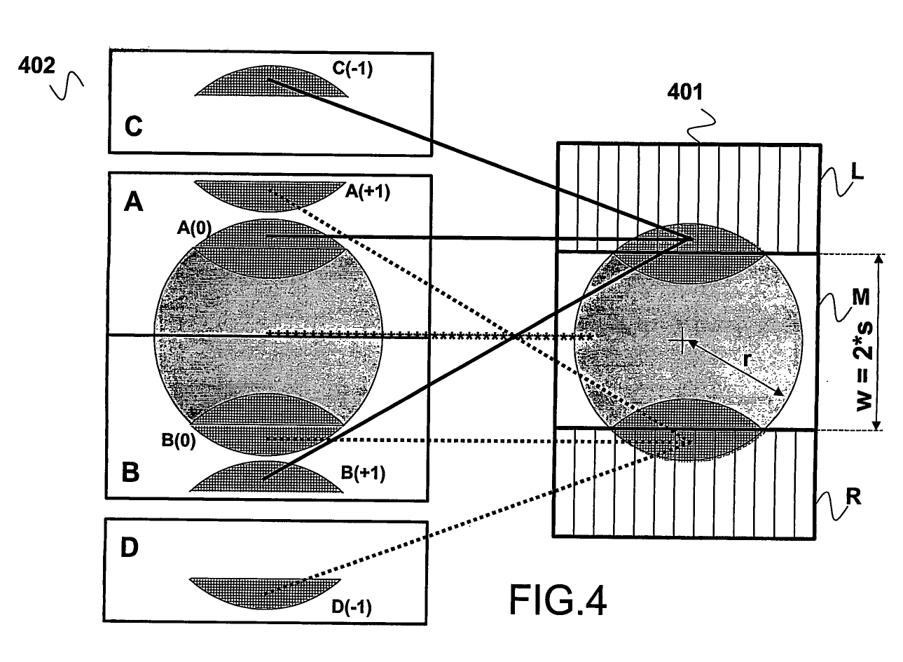

With a photodetector comprising only a first segment A and a second segment B, the −1st diffraction orders generated by the first side portion L and the second side portion R are not detected since they do not fall on the segments. To take advantage of the −1st diffraction orders, an improved photodetector is proposed in FIG. 4.

FIG. 4 depicts an optical element 401 according to the invention intended to generate diffracted and non-diffracted light beams on a second type of photodetector 402.

The photodetector 402 differs from the photodetector as depicted in FIG. 3 in that it comprises also a first side segment C and a second side segment D.

In particular, the photodetector 402 is intended to detect the −1st, 0th and +1st diffraction orders generated by an optical element 401 corresponding, for example, to a grating having a binary structure. Indeed, the first side portion L of the optical element 401 comprises diffraction means for generating a third non-0th diffraction order light beam C(−1) on said first side segment C, and the second side portion R comprises diffraction means for generating a fourth non-0th diffraction order light beam D(−1) on said second side segment D. The third and fourth non-zero diffraction orders correspond to −1st diffraction orders.

In a photodetector comprising a first segment A and a second segment B, the push-pull signal PP is defined by the following relation:
PP=S(A)−S(B) Eq. 3

where S(A) is the signal generated by the first segment A,
S(B) is the signal generated by the second segment B.

Both the first segment A and the second segment B have contributions from the 0th and non-0th orders from portions M, L, and R of the optical element. The signals S(A) and S(B) are expressed as follows:
S(A)=(ca0−ca1)e+(Da0−Da1)cos(2π.x/tp−Φ) Eq. 4
S(B)=−(cb0−cb1)e+(Db0−Db1)cos(2π.x/tp+Φ) Eq. 5

where ca0 is the beamlanding coefficient for segment A resulting from the 0th order beams originating from the central and first and second side portions of the optical element 107,

ca1 is the beamlanding coefficient for segment A resulting from the 1st order beams originating from the second side portion R of the optical element 107,

cb0 is the beamlanding coefficient for segment B resulting from the 0th order beams originating from the central and first and second side portions of the optical element 107,

cb1 is the beamlanding coefficient for segment B resulting from the 1st order beams originating from the first side portion L of the optical element 107,

Da0 is the signal amplitude on segment A resulting from the 0th order beams originating from the central and first and second side portions of the optical element 107,

Db0 is the signal amplitude on segment B resulting from the 0th order beams originating from the central and first and second side portions of the optical element 107,

Da1 is the signal amplitude on segment A resulting from the 1st order beams originating from the second side portion R of the optical element 107,

Db1 is the signal amplitude on segment B resulting from the 1st order beams originating from the first side portion L of the optical element 107,

e is the displacement of the objective lens with respect to the beam (e is known as “beamlanding”),

x is the radial position of the scanning spot,

tp is the track pitch of the optical disc,

Φ is a phase term.

In Eq. 4 and Eq. 5, the beamlanding contributions correspond to the multiplication factors (ca0−ca1) and −(cb0−cb1) applied to the displacement e, while the radial scanning position is expressed by the oscillating terms in cos.

Due to the symmetric arrangement of the optical pickup apparatus along the optical path:
ca0=cb0=c0 Eq. 6
ca1=cb1=c1 Eq. 7
Da0=Db0=D0 Eq. 8
Da1=Db1=D1 Eq. 9

Eq. 4 and Eq. 5 can thus be expressed as follows:
S(A)=(c0−c1)e+(D0−D1)cos(2π.x/tp−Φ) Eq. 10
S(B)=−(c0−c1)e+(D0−D1)cos(2π.x/tp+Φ) Eq. 11

The push-pull signal PP is thus expressed as follows:
PP=2(c0−c1)e+2(D0−D1)sin(Φ)sin(2π.x/tp) Eq. 12

In Eq. 12, the DC offset caused by the beamlanding is cancelled if c0=c1, leading to:
PP=2(D0−D1)sin(Φ)sin(2π.x/tp) Eq. 13

An improved push-pull signal expressed by Eq. 13 is obtained by tuning parameters such as the width w=2*s of the central portion M of the optical element, and the blaze height h which determines the grating diffraction efficiency of the diffracted beams.

In a photodetector comprising a first segment A, a second segment B, a first side segment C, and a second side segment D, the push-pull signal PP is defined by the following relation:
PP=S(A)−S(B)+K.[S(C)−S(D)] Eq. 14

where S(A) is the signal generated by the segment A,
S(B) is the signal generated by the segment B,
S(C) is the signal generated by the segment C,
S(D) is the signal generated by the segment D,
K is a gain factor.

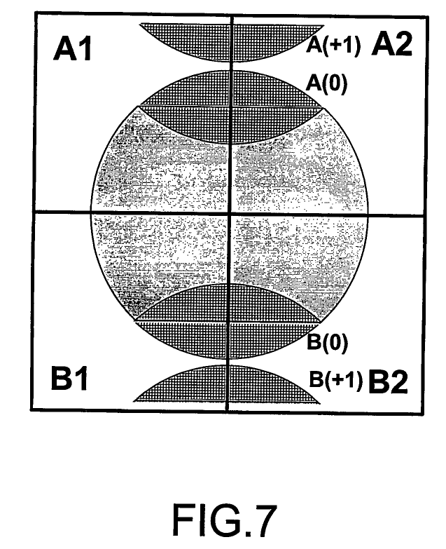

FIG. 7 depicts a third type of photodetector used in the invention. It differs from the photodetectors as depicted in FIG. 3 and FIG. 4 in that:
the first segment A comprises a first sub-segment A1 and a second sub-segment A2,
the second segment B comprises a third sub-segment B1 and a fourth sub-segment B2.

The push-pull signal is still expressed by Eq. 3 and Eq. 14 in which:
S(A)=S(A1)+S(A2) Eq. 15
S(B)=S(B1)+S(B2) Eq. 16

where S(A1) is the signal generated by the segment A1,
S(A2) is the signal generated by the segment A2,
S(B 1) is the signal generated by the segment B 1,
S(B2) is the signal generated by the segment B2.
   This photodetector provides the generation of a focus error signal by the astigmatic method.

The words “comprises”, “comprise” and “comprising” do not exclude the presence of other elements than those listed in the claims.

1. Optical pickup apparatus comprising a photodetector (302) which comprises a first segment (A) and a second segment (B), and an optical element (301) intended to receive an incident light beam, said optical element (301) comprising:
a first portion (L) comprising diffraction means for generating a first 0th diffraction order light beam (A(0)) on said first segment (A), and a first non-0th diffraction order light beam (B(+1)) on said second segment (B),
a second portion (R) comprising diffraction means for generating a second 0th diffraction order light beam (B(0)) on said second segment (B), and a second non-0th diffraction order light beam (A(+1)) on said first segment (A).

2. Optical pickup apparatus as claimed in claim 1, wherein:
said photodetector (302) comprises a first side segment (C) and a second side segment (D),
said first portion (L) comprises diffraction means for generating a third non-0th diffraction order light beam (C(−1)) on said first side segment (C),
said second portion (R) comprises diffraction means for generating a fourth non-0th diffraction order light beam (D(−1)) on said second side segment (D)).

3. Optical pickup apparatus as claimed in claim 1, wherein said first portion (L) and said second portion (R) have saw tooth grating structures with mutually opposed angles.

4. Optical pickup apparatus as claimed in claim 1 or 2, wherein said first portion (L) and said second portion (R) have a binary grating structure.

5. Optical pickup apparatus as claimed in one of the claims 1 to 4, wherein:
said first segment (A) comprises a first sub-segment (A1) and a second sub-segment (A2),
said second segment (B) comprises a third sub-segment (B1) and a fourth sub-segment (B2).

6. Optical pickup apparatus as claimed in one of the claims 1 to 5, wherein said optical element (301) comprises a third portion (M) arranged between said first portion (L) and said second portion (R).

7. Optical pickup apparatus as claimed in claim 6, wherein said third portion (M) has a rectangular shape with a width 2*s, where s complies with 0.05*r<s<0.95*r, r being the radius of said incident light beam.
